(19) United States
(12) Patent Application Publication
(10) Pub. No.: US 2003/0210090 A1
(43) Pub. Date: Nov. 13, 2003

(54) Internal power voltage generating circuit of semiconductor memory device and internal power voltage controlling method thereof

(76) Inventors: Choong-Keun Kwak, Suwon-City (KR); Du-Eung Kim, Yongin-City (KR); Jong-Pil Son, Yongin-City (KR)

Correspondence Address: LEE & STERBA, P.C., 1101 Wilson Boulevard, Suite 2000, Arlington, VA, 22209, US

(21) Appl. No.: 10/367,932

(22) Filed: Feb. 19, 2003

(30) Foreign Application Priority Data
May 10, 2002 (KR) 2002-25753

(51) Int. Cl. G05F 1/10

(52) U.S. Cl. 327/540

(57) ABSTRACT

An internal power voltage generating circuit of a semiconductor memory device for decreasing electric power consumption during a long cycle operation and for minimizing an internal power voltage drop caused by peak current consumption during a short cycle operation preferably includes a reference voltage generator for generating reference voltages, a pulse generator for generating an address shift detecting signal in response to a control signal, and at least one driver stage for generating an internal power voltage in response to a normal enable signal and the address shift detecting signal. A method for controlling an internal power voltage generator preferably includes preparing current sinks as a plurality of current sink paths to operate the driver stage that generates the internal power voltage and controlling one current sink path out of the plurality of current sink paths with an active operation-detecting signal.

### BACKGROUND OF THE INVENTION

1. Field of the Invention

The present invention relates to internal power voltage generation. More particularly, the present invention relates to an internal power voltage generating circuit of a semiconductor memory device and a method-for controlling an internal power voltage.

2. Description of the Related Art

As semiconductor memory devices become more highly integrated and acquire higher performance speeds, internal power voltage is typically supplied as a lower voltage level to an internal side of a chip in order to minimize electrical power consumption and improve device reliability. Accordingly, an internal power voltage generating circuit is required to decrease a relatively higher level of external power voltage to a desirable lower voltage level required for operation of the semiconductor memory device. Particularly, when a range of operational power voltage is broad, most conventional non-synchronous low electric power SRAMs employ an internal power voltage generating circuit (Internal Voltage Down Converter) for converting the external power voltage having a broad range of values to a lower, constant, internal power voltage for biasing an internal circuit of a chip.

The conventional internal power voltage generating circuit typically includes a reference voltage generator and a driver stage. The driver stage includes a current mirror type differential amplifier having a current sink that is generally formed of a single path for operating the driver stage. The driver stage compares a reference voltage output from the reference voltage generator with an internal power voltage and generates a desired output voltage. However, when a semiconductor memory device uses a conventional internal power voltage generating circuit, a large amount of current is instantaneously consumed when word lines or sense amplifiers are activated, thereby causing a significant drop in the internal power voltage. Such voltage drops can significantly affect the reliability and performance of the semiconductor memory device by causing an average operational current characteristic in a long cycle to be abnormal.

Therefore, an internal power voltage generating circuit is needed in which return to an internal power voltage level occurs rapidly. Concurrently, a method for controlling the internal power voltage generating circuit is needed, in which a return to a predetermined internal power voltage level is accelerated to occur more rapidly than in a conventional device.

### SUMMARY OF THE INVENTION

In an effort to solve the aforementioned problems, it is a feature of an embodiment of the present invention to provide a semiconductor memory device having an internal power voltage generating circuit which is characterized by a rapid response speed in the restoration of an internal power voltage level under transient high current, voltage drop conditions, and a method for controlling the same.

It is another feature of an embodiment of the present invention to provide an internal power voltage generating circuit of a semiconductor memory device and an internal power voltage controlling method thereof having a reduced electric power consumption during a long cycle of semiconductor memory device operation and in which an internal power voltage drop caused by peak current consumption in a special range may be minimized or reduced during a short cycle of semiconductor memory device operation.

It is another feature of an embodiment of the present invention to provide an internal power voltage generating circuit of a semiconductor memory device and an internal power voltage controlling method thereof by which a response time to a voltage drop in a driver stage may be reduced.

It is another feature of an embodiment of the present invention to provide an internal power voltage generating circuit of a semiconductor memory device and an internal power voltage controlling method thereof by which power consumption may be minimized or reduced during a memory device operation.

It is another feature of an embodiment of the present invention to provide an internal power voltage generating circuit of a semiconductor memory device and an internal power voltage controlling method thereof by which variances in an internal power voltage applied to an internal circuit of a chip may be reduced.

It is yet another feature of an embodiment of the present invention to provide an internal power voltage generating circuit of a semiconductor memory device and an internal power voltage controlling method thereof by which an average operational current characteristic in a semiconductor memory may be improved.

It is a still another feature of an embodiment of the present invention to provide an internal power voltage generator having a current sink that uses a plurality of paths.

It is yet another feature of an embodiment of the present invention to provide an internal power voltage generating circuit of a semiconductor memory device and an internal power voltage controlling method thereof by which at least one of a plurality of current sink paths necessary to operate a driver stage with an address-shift detecting signal is capable of being controlled. Further, at least one of the plurality of current sink paths is formed only during a predetermined operational cycle.

An internal power voltage generating circuit of a semiconductor memory device according to the present invention preferably includes a reference voltage generator for generating reference voltages, a pulse generator for generating an address shift detecting signal, and at least a first driver stage for generating an internal power voltage in response to the reference voltages and the address shift detecting signal and supplying the internal power voltage to at least one power source. The driver stage of the internal power voltage generating circuit preferably includes a current mirror type differential amplifier for amplifying a difference between a level of a reference voltage and a level of an internal power voltage output in response to a normal enable signal that controls a first current sink; a driver for driving an external power voltage in response to an output of a first output terminal of the differential amplifier to thereby output the internal power voltage; and an active power drop preventing part for activating a path of a second current sink during a predetermined time period in response to the address shift detecting signal that is applied independently of the normal enable signal, the active power drop preventing part forming the second current sink that is connected parallel to the first current sink of the differential amplifier.

The second current sink may have a larger driving capacity than the first current sink. The pulse generator preferably includes an address shift detecting apparatus for detecting shifts of an address signal and/or a data signal. The pulse generator preferably outputs an address shift detection signal in the semiconductor memory device. The first driver stage may further include a second driver stage that operates in response to an input of an external power voltage, and the second driver stage may have a smaller driving capacity than the first driver stage.

In a second embodiment of the present invention, the internal power voltage generating circuit may further include a first internal power voltage generating circuit for supplying an internal power voltage to a memory cell array and a second internal power voltage generating circuit for supplying an internal power voltage to a peripheral circuit region. The first internal power voltage generating circuit may have a same circuit structure as or a different circuit structure from the second internal power voltage generating circuit.

In a third embodiment of the present invention, an internal power voltage generating circuit of a non-synchronous semiconductor memory device preferably includes a reference voltage generator for generating first and second reference voltages; a pulse generator for generating an address shift detecting signal; first and second driver stages for generating first and second internal power voltages, respectively, in response to the first and second reference voltages and the address shift detecting signal to thereby supply the first and second internal power voltages to first and second power sources in the memory device. A level of the first reference voltage may be the same as or different from a level of the second reference voltage. The first power source receiving the first internal power voltage may be a memory cell array region, and the second power source receiving the second internal power voltage may be a circuit region circuit region.

The first and second driver stages may be further connected to a third and a fourth driver stage that operate in response to an input of an external power voltage. The third and fourth driver stages may each have a smaller driving capacity than the first and second driver stages.

In an embodiment of the present invention, an internal power voltage controlling method for a non-synchronous semiconductor memory device is provided, the method including preparing current sinks as a plurality of current sink paths to operate at least one driver stage that generates an internal power voltage to meet a reference voltage level and controlling at least one current sink path out of the plurality of current sink paths with an active operation-detecting signal. The active operation-detecting signal may be an address shift detecting signal that is created by detecting a shift of an address signal or a shift of a data signal. The driver stage preferably includes a current mirror type of differential amplifier having a plurality of current sink paths.

In another embodiment of the present invention, an internal power voltage controlling method of a non-synchronous static random access memory is provided, including preparing current sinks as a plurality of current sink paths to operate at least one driver stage that generates an internal power voltage having a level different from an external power voltage to meet a reference voltage level, and controlling at least one current sink path out of the plurality of current sink paths with a shift pulse signal generated during an active operation of the static random access memory only during a predetermined period of time. In this method, the at least one current sink path is preferably in parallel with a conducting normal current sink path, which is preferably enabled by at least one of a chip selection signal and a reference voltage. Also in this method, the shift pulse signal may be an address shift detecting signal.

Advantageously, according to an embodiment of the present invention, separately added current sink paths are additionally formed only during a predetermined operational cycle. Therefore, electric power consumption may be reduced during a long cycle operation of a semiconductor memory device, and an internal voltage having experienced a drop due to peak current consumption may be rapidly restored to the original state during a short cycle operation of the semiconductor memory device, thereby minimizing or decreasing changes in the internal power voltage.

### BRIEF DESCRIPTION OF THE DRAWINGS

These and other features and advantages of the present invention will become more apparent to those of ordinary skill in the art by the following detailed description of preferred embodiments thereof with reference to the attached drawings in which:

FIG. 1 illustrates a block diagram showing an electrical connection structure of an internal power voltage generating circuit according to an embodiment of the present invention.

FIG. 2 illustrates an exemplary detailed circuit diagram of a driver stage of FIG. 1.

FIG. 3 illustrates an exemplary circuit diagram of a pulse generator of FIG. 1.

FIG. 4 illustrates an operational timing diagram of the pulse generator as shown in FIG. 3.

FIG. 5 illustrates a supply timing diagram of a long-cycle operational current according to an operation of the driver stage shown in FIG. 1.

FIG. 6 illustrates simulation graphs showing changes in a power supply of the semiconductor memory device according to the present invention and in a conventional semiconductor memory device.

FIG. 7 illustrates an operational timing diagram for controlling the internal power voltage supply by separately inputting the address shift-detecting signal according to an embodiment of the present invention.

### DETAILED DESCRIPTION OF THE INVENTION

Korean Patent Application No. 2002-25753, filed May 10, 2002, and entitled “Internal Power Voltage Generating Circuit of Semiconductor Memory Device and Internal Power Voltage Controlling Method Thereof” is incorporated by reference herein in its entirety.

The present invention will now be described more fully with reference to the accompanying drawings, in which preferred embodiments of the invention are shown, and in which like reference numerals denote like parts throughout. The invention may, however, be embodied in different forms and should not be construed as limited to the embodiments set forth herein. Rather, these embodiments are provided so that this disclosure will be thorough and complete, and will fully convey the concept of the invention to those of ordinary skill in the art.

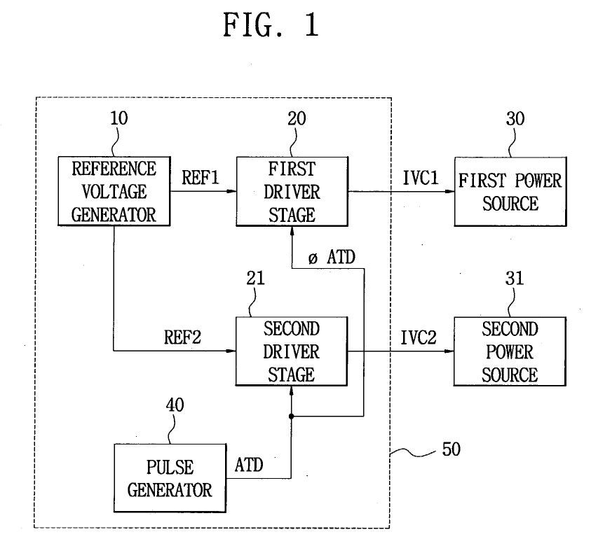

FIG. 1 shows the electrical connection structure of an internal power voltage generating circuit 50 according to an embodiment of the present invention. The internal power voltage generating circuit 50 of a semiconductor memory device preferably comprises a reference voltage generator 10 for generating first and second reference voltages REF1 and REF2, respectively, a pulse generator 40 for generating an address shift detecting signal (ATD) in response to a shift of an address signal, and first and second driver stages 20 and 21, respectively. First and second driver stages 20 and 21, respectively, generate internal power voltages IVC1 and IVC2 corresponding to levels of the first and second reference voltages, respectively, in response to a normal enable signal and the address shift detecting signal (ATD), to supply the internal power voltages IVC1 and IVC2 to the corresponding power sources 30 and 31, respectively. A level of the first reference voltage IVC1 may be the same as or different from a level of the second reference voltage IVC2. The first power source 30 that receives the first internal power voltage IVC1 may be a cell array region, and the second power source 31 that receives the second internal power voltage IVC2 may be a peripheral circuit region.

In normal operation according to the present invention, first and second driver stages 20 and 21, respectively, each generate two voltages depending on a state of output power consumption. When the output power consumption is relatively small, driver stages 20 21 generate a first internal power voltage in response to a normal enable signal. When the output power consumption is relatively large, driver stages 20 21 generate a second internal power voltage in response to both the normal enable signal and the address shift detecting signal ADT by increasing the slew rate of the respective driver stage and thereby minimizing or reducing changes (i.e. voltage drops) in the internal power voltage.

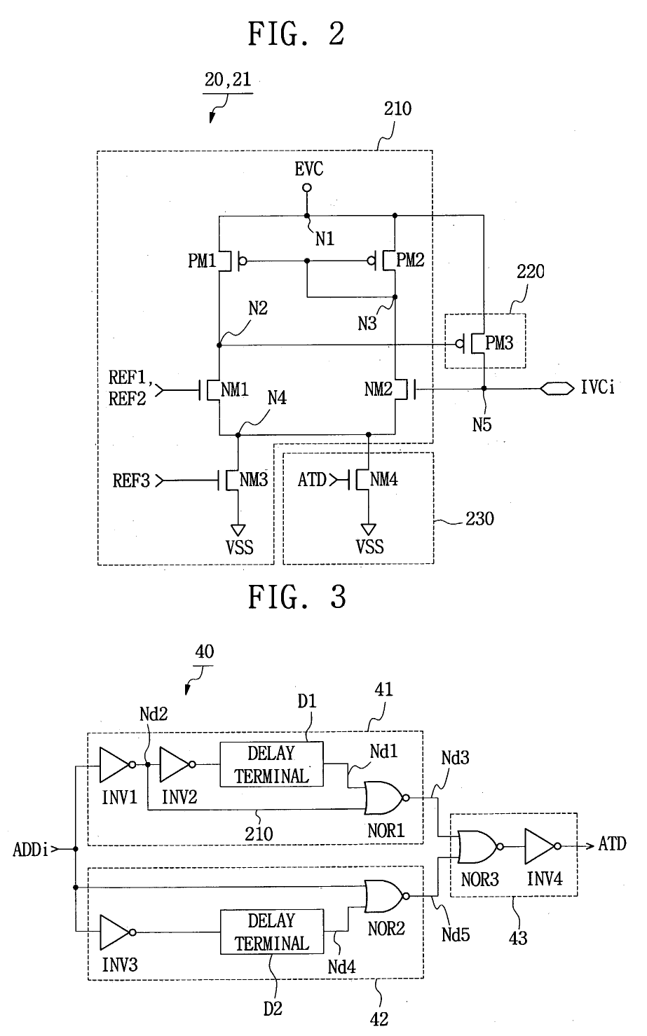

FIG. 2 shows a preferred detailed circuit diagram of driver stages 20 and 21. The driver stages 20 and 21 each include a current mirror type differential amplifier 210 for amplifying a difference between levels of a reference voltage REFi (i.e. REF1 and REF2) and an internal power voltage IVCi in response to normal enable signals such as a reference signal REF3 or a chip select signal for controlling a first current sink. The driver stages 20 and 21 further include a driver 220 for driving an external power voltage in accordance with an output of a first output terminal N2 of the differential amplifier 210 to thereby output the internal power voltage, and an active power drop preventing part 230 for activating current sink paths only during a predetermined period of time in response to the address shift detecting signal ATD that is applied independently of the normal enable signal. The active power drop preventing part 230 is connected between ground and a node N4 of a second current sink NM2 that is connected parallel to a first current sink NM3 of the differential amplifier 210.

Preferably, the differential amplifier 210 includes PMOS transistors PM1 and PM2 having sources commonly receiving an external power voltage EVC and gates connected to each other; NMOS transistors NM1 and NM2 having drains connected to the drains of the PMOS transistors PM1 and PM2, respectively; and an NMOS transistor NM3 providing a current sink having a source connected to ground and a drain connected to the sources of NMOS transistors NM1 and NM2. In FIG. 2, the node N2 represents a first output terminal of the differential amplifier 210, node N3 represents a second output terminal, and the node N4 is attached to current sink NM3. In addition, a gate of the NMOS transistor NM1 represents a first input terminal of the differential amplifier 210, a gate of the NMOS transistor NM2 represents both a second input terminal and an output terminal of the driver stages 20 and 21 that generates the internal power voltage IVCi.

The driver 220 is preferably formed of the PMOS transistor PM3 having a gate connected to the first output terminal N2 of the differential amplifier 210, a source receiving the external power voltage EVC, and a drain connected to input/output node N5 to output the internal power voltage IVCi. The active power drop preventing part 230 is preferably formed of an NMOS transistor NM4 having a drain-source channel connected between a current sink node N4 of the differential amplifier 210 and ground VSS, respectively, and a gate receiving the address shift detecting signal ATD that is applied independently of the normal enable signal REF3.

For cases where the current sink of differential amplifier 210 is formed having multiple paths, the active power drop preventing part 230 may be extended accordingly, that is, the active power drop preventing part 230 may have a current sink for each additional path in the differential amplifier 210. Further, a chip select signal or a signal created by detecting a shift of a data signal may be used in addition to the address shift detecting signal.

FIG. 3 shows an exemplary pulse generator 40 of FIG. 1. Referring to FIG. 3, a rising edge detector 41 detects a rising of an address signal ADDi to generate a plurality of pulse signals having a predetermined time period. A falling edge detector 42 detects a falling of the address signal ADDi to generate a plurality of pulse signals having a predetermined time period. A logic gating part 43 logically combines the pulse signals that are generated by the rising edge detector 41 and the falling edge detector 42, and outputs a pulse type address detecting shift signal ADT.

The rising edge detector 41 may further include an inverter INV1 for inverting the address signal ADDi prior to supplying the address signal ADDi to a node Nd2 so that the inverse of ADDI is supplied to node Nd2; an inverter INV2 for inverting the output of the inverter INV1; a delay terminal D1 for delaying an output of the inverter INV2 by a predetermined time period to supply the delayed output of the inverter INV2 to a node Nd1; and a NOR gate NOR1 for receiving output signals of the nodes Nd1 and Nd2 to supply a NOR response signal to a node Nd3. The falling edge detector 42 may further include an inverter INV3 for inverting the address signal ADDi; a delay terminal D2 for delaying an output of the inverter INV3 by a predetermined time period to supply the delayed output of the inverter INV3 to a node Nd4; and a NOR gate NOR2 for receiving the signal at node Nd4 and the address signal ADDi to supply a NOR response signal to the node Nd5. The logic gating part 43 may further include a NOR gate NOR3 for receiving output signals of the nodes Nd3 and Nd5 and generating a NOR response signal, and an inverter INV4 for inverting the NOR response signal to generate the address shift detecting signal ATD.

In a non-synchronous type static random access memory (SRAM) device having a relatively rapid access operation and not requiring a refresh operation as is necessary in a dynamic random access memory, an access operation may be performed with reference to an internally generated clock signal, i.e., without receiving an external clock pulse. Typically, such devices are provided with an address shift detector for generating the clock signal internally. Thus, when the present invention is employed in a non-synchronous type SRAM, the address shift detecting signal (ATD) may be obtained from the address shift detector.

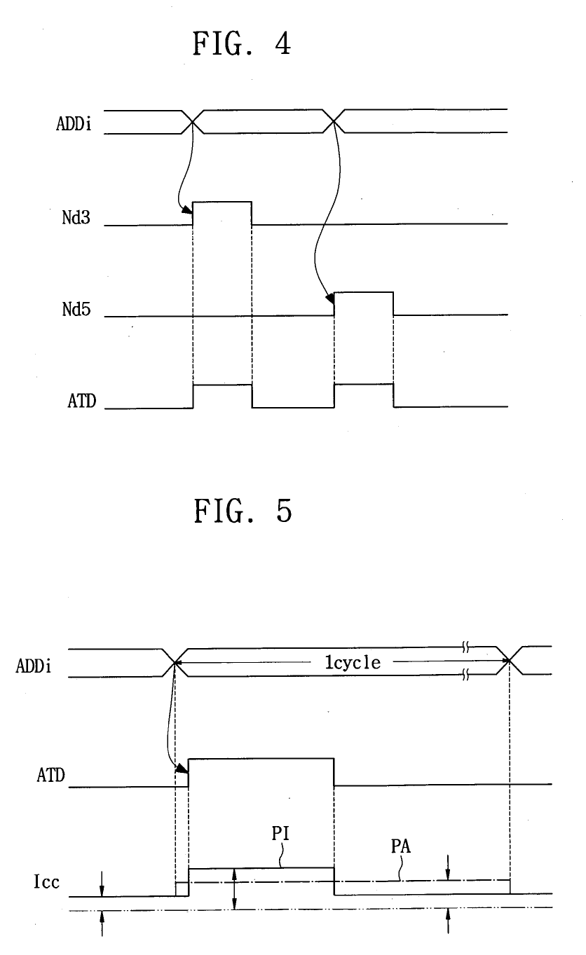

FIG. 4 illustrates an operational timing diagram of the exemplary pulse generator 40 shown in FIG. 3. Referring to FIG. 4, when the address signal ADDi is applied to pulse generator 40, waveforms Nd3 and Nd5 represent signals generated at nodes Nd3 and Nd5, respectively, in response to the transitions of the ADDi signal. The logic gating part 43 of pulse generator 40 outputs the address shift detecting signal ATD represented by a corresponding exemplary address shift detecting waveform ATD in FIG. 4.

FIG. 5 illustrates an exemplary supply-timing diagram of a long cycle operation current during an operation of the driver stage 20 and/or 21 of FIG. 1. Referring to FIG. 5, the waveform “ADDi” indicates an address signal or a data signal that is applied to the pulse generator 40 shown in FIG. 3. Waveform “ATD” represents address shift detecting signal ATD, which is applied to a gate of the NMOS transistor NM4 of the active power drop preventing part 230 in the driver stage 20 and/or 21 as shown in FIG. 2. In response to the ATD signal, NMOS transistor NM4 is turned on to form an additional current sink path in parallel with the normal current sink path provided by NMOS transistor NM3. As a result, the differential amplifier 210 in the driver stage 20 and/or 21 has faster response characteristics than without the additional current sink path, and rapidly restores any internal power voltage drop to the original level. Thus, changes in the internal power voltage may be minimized or reduced.

Unlike the conventional waveform indicated by waveform PA in FIG. 5, the average operational current Icc of a semiconductor memory device according to the present invention increases only during a predetermined time period corresponding to the predetermined operational period of time, and decreases during a remaining time period, as indicated by exemplary waveform PI of FIG. 5. Since the additional current sink path through NMOS transistor NM3 is only activated during the predetermined operational period of time, power consumption may be reduced during a long cycle of semiconductor memory device operation. Further, during a short cycle of semiconductor memory device operation, the internal power voltage drop caused by a peak current consumption condition may be rapidly restored to the original level, thereby minimizing or reducing changes in the internal power voltage.

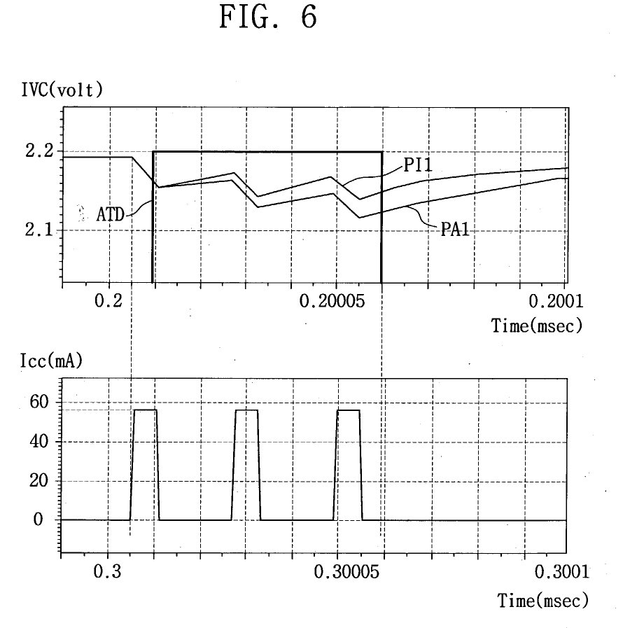

FIG. 6 shows simulation graphs for comparing power supply change rates in a semiconductor memory device according to the present invention with power supply change rates in a conventional semiconductor memory device.

Specifically, in the upper graph of FIG. 6, the transverse axis indicates time in a unit of msec, and the longitudinal axis indicates changes in an internal power voltage using a unit of Volts. The symbol “PA1” corresponds to a conventional semiconductor memory device and the symbol “PI1” corresponds to the present invention. In the lower graph of FIG. 6, the transverse axis indicates time in a unit of msec and the longitudinal axis indicates internal power in a unit of mA, thereby showing an example of internal current consumption. In both graphs of FIG. 6, peak current consumption conditions occur in the exemplary predetermined operational time period indicated in the upper graph by application of the address shift-detecting signal ADT, and in the lower graph by high current pulses shown in waveform Icc. Waveform PI1 represents a typical voltage response to the high current pulses in Icc that would occur when employing the embodiments of the present invention. For comparison, waveform PA1 represents a conventional voltage response that would occur without the present invention. During the period of peak current consumption condition, the voltage PI1 applied to the memory device in the present invention exhibits minimal changes, and any transient voltage drops that occur are more rapidly restored to a desired level than in a conventional memory device as shown by waveform PA1. Thus, it is desirable to have a plurality of current sink paths, with at least one current sink path being controlled by the address shift-detecting signal.

In order to better understand the timing diagrams of FIG. 6, operation of the circuit of FIG. 2 will be explained in more detail. When NMOS transistor NM4 is turned off, current through the differential amplifier 210 and the driver 220 is routed through the current sink NMOS transistor NM3, which is turned on.

For example, assuming that bias is set such that transistors may operate in a saturated region, the NMOS transistor NM1 is turned on more strongly than the NMOS transistor NM2 when a voltage level of the reference voltage REF1 is higher than a voltage level of the node N5. In contrast, the NMOS transistor NM2 is turned on less than the NMOS transistor NM1. Accordingly, an amount of electric current that flows through the node N2 is more than that which flows through the node N3. Therefore, the voltage level of the node N2 becomes lower than that of a normal state, causing an increase in the conduction current in PMOS transistor PM3 of driver 220, thereby raising the voltage level of node N5. When the level of the internal power voltage IVCi increases and becomes higher than the reference voltage REF1, the NMOS transistor NM2 is turned on more strongly than the NMOS transistor NM1 thereby causing the voltage level at node N2 to continuously increase. As a result, the PMOS transistor PM3 receives a relatively high voltage at the gate thereof and is finally turned off. Through the foregoing operation, the level of the internal power voltage IVCi tracks the reference voltage.

Further, when the address shift detecting signal ATD is not input, since only a normal current sink path is formed by the transistor NM3, electric power is saved when the size of the transistor NM3 is small. Typically, the size of the NMOS transistor NM3 is larger than that of the transistor NM4. However, for alternative implementations of the semiconductor memory device, NM4 may selectively be larger than NM3.

When address shift detecting signal ATD is applied according to the present invention, NMOS transistor NM4 is turned on. In this case, the control operation by which the NMOS transistor NM4 of the driver 220 is turned on or off is directly related to a desired response time of the driver stage. According to the present invention, the ability of the current sink to be effectively operated only during a special period of time where current consumption is relatively large allows the response time characteristic to be improved. In other words, the address shift detecting signal that is input when current consumption becomes large is supplied to the transistor NM4, thereby increasing the capacity of the current sink. Thus, the NMOS transistors NM3, NM4 are turned on such that a plurality of current sink paths are formed, thereby changing the operation of the differential amplifier to a rapid response mode. As before, since the capacity of the current sink increases only when it is necessary, the current consumption may be significantly reduced during an average operation at a long cycle as compared with a conventional prior art implementation.

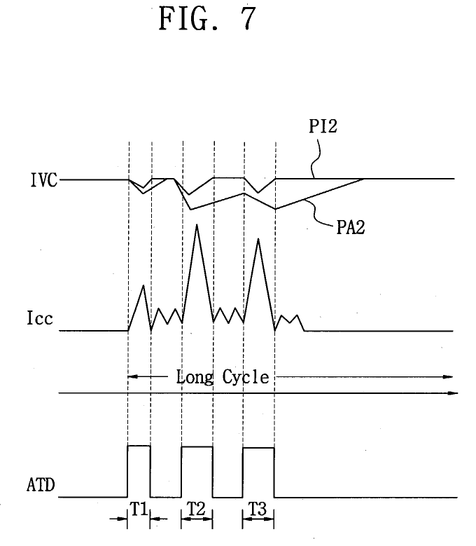

FIG. 7 illustrates an operational timing diagram for controlling the internal power voltage supply by separately inputting the address shift-detecting signal ATD to meet the peak current demand during each of periods T1, T2 and T3 during a long cycle. Waveform PI2 represents the internal power voltage in response to an ATD signal according to the embodiments of the present invention, while waveform PA2 represents a voltage response using conventional implementations. Comparing waveform PI2 with waveform PA2, it is apparent that the degree of voltage drop in the present invention is significantly reduced during periods of high current consumption as compared to the voltage drop occurring in a conventional implementation. The reason for the decreased voltage drop in the internal power voltage in response to an ATD signal in the present invention is the increased slew rate that results from the increased current sinking of the present invention.

A preferred embodiment of the present invention has been disclosed herein and, although specific terms are employed, they are used in a generic and descriptive sense only and not for purpose of limitation. Accordingly, it will be understood by those of ordinary skill in the art that various changes in form and details may be made without departing from the spirit and scope of the invention as set forth in the following claims.

For example, it may be appreciated that the outputs from the first and second drivers 20 and 21 may be supplied to a third and a fourth driver (not shown) in order to generate additional internal voltages as required in the memory device.

What is claimed is:

1. An internal power voltage controlling method of a non-synchronous semiconductor device, comprising:
preparing current sinks as a plurality of current sink paths to operate at least one driver stage that generates an internal power voltage to meet a reference voltage level, and
controlling at least one of the plurality of current sink paths with an active operation-detecting signal.

2. The method as claimed in claim 1, wherein the active operation-detecting signal is an address shift detecting signal that is created by detecting a shift of an address signal or a shift of a data signal.

3. The method as claimed in claim 1, wherein the driver stage comprises a current mirror type differential amplifier having a plurality of current sink paths.

4. An internal power voltage controlling method of a non-synchronous static random access memory, comprising:
preparing current sinks as a plurality of current sink paths to operate at least one driver stage that generates an internal power voltage having a level different from an external power voltage to meet a reference voltage level, and
controlling at least one of the plurality of current sink paths with a shift pulse signal generated only during a predetermined period of time of an active operation of the static random access memory.

5. The method as claimed in claim 4, wherein the shift pulse signal is an address shift detecting signal.

6. The method as claimed in claim 4, wherein the at least one of the plurality of current sink paths is in parallel with a conducting normal current sink path.

7. The method as claimed in claim 6, wherein the conducting normal current sink path is enabled by at least one of a chip selection signal and a reference voltage.

8. An internal power voltage generating circuit of a semiconductor memory device, comprising:
a reference voltage generator for generating reference voltages,
a pulse generator for generating an address shift detecting signal, and
at least a first driver stage for generating an internal power voltage in response to the reference voltages and the address shift detecting signal and supplying the internal power voltage to at least one power source.

9. The circuit as claimed in claim 8, wherein the driver stage comprises:
a current mirror type differential amplifier for amplifying a difference between a level of a reference voltage and a level of an internal power voltage output in response to a normal enable signal that controls a first current sink;
a driver for driving an external power voltage in response to an output of a first output terminal of the differential amplifier to thereby output the internal power voltage; and
an active power drop preventing part for activating a path of a second current sink during a predetermined time period in response to the address shift detecting signal that is applied independently of the normal enable signal, the active power drop preventing part forming the second current sink that is connected parallel to the first current sink of the differential amplifier.

10. The circuit as claimed in claim 9, wherein the second current sink has a larger driving capacity than the first current sink.

11. The circuit as claimed in claim 9, wherein the pulse generator includes an address shift detecting apparatus for detecting shifts of an address signal and/or a data signal.

12. The circuit as claimed in claim 8, wherein the first driver stage includes a second driver stage that operates in response to an input of an external power voltage.

13. The circuit as claimed in claim 12, wherein the second driver stage has a smaller driving capacity than the first driver stage.

14. The circuit as claimed in claim 13, wherein the internal power voltage generating circuit comprises a first internal power voltage generating circuit for supplying an internal power voltage to a memory cell array; and a second internal power voltage generating circuit for supplying an internal power voltage to a peripheral circuit region.

15. The circuit as claimed in claim 14, wherein the first internal power voltage generating circuit has a same circuit structure as the second internal power voltage generating circuit.

16. An internal power voltage generating circuit of a non-synchronous semiconductor memory device, comprising:
a reference voltage generator for generating first and second reference voltages;
a pulse generator for generating an address shift detecting signal;
first and second driver stages for generating first and second internal power voltages, respectively, in response to the first and second reference voltages and the address shift detecting signal to thereby supply the first and second internal power voltages to first and second power sources in the memory device.

17. The circuit as claimed in claim 16, wherein the reference voltage generator generates the second reference voltage at a level different from a level of the first reference voltage.

18. The circuit as claimed in claim 16, wherein the reference voltage generator generates the second reference voltage at the same level as the first reference voltage.

19. The circuit as claimed in claim 16, wherein, when the first power source receiving the first internal power voltage is a memory cell array region, the second power source receiving the second internal power voltage is a peripheral circuit region.

20. The circuit as claimed in claim 16, wherein the first and second driver stages are further connected to third and fourth driver stages that operate in response to an input of an external power voltage.

21. The circuit as claimed in claim 20, wherein the third and fourth driver stages each have a smaller driving capacity than the first and second driver stages.
